(19) United States
(12) Patent Application Publication
(10) Pub. No.: US 2018/0141293 A1
(43) Pub. Date: May 24, 2018

(54) METHOD FOR MAKING OPHTHALMIC LENSES

(71) Applicant: Novartis AG, Basel (CH)

(72) Inventor: Harald Bothe, Niedernhausen (DE)

(21) Appl. No.: 15/813,377

(22) Filed: Nov. 15, 2017

Related U.S. Application Data
(60) Provisional application No. 62/424,103, filed on Nov. 18, 2016.

(51) Int. Cl. B29D 11/00; G02B 1/14

(52) U.S. Cl. CPC B29D 11/00865; G02B 1/043; G02B 1/14; B29D 11/00125

(57) ABSTRACT

Described herein is a cost-effective and time-efficient method for making contact lenses having a hydrophilic surface and a reduced uptake of cationic compounds, e.g. from care solutions. The method is based on conducting one of the process steps in the presence of an amino-C2-4-alkyl (meth) acrylamide or an C1-4 alkyl-amino-C2-4-alkyl (meth) acrylamide.

This application claims the benefits under 35 USC § 119 (e) of U.S. provisional application No. 62/424,103 filed 18 Nov. 2016, herein incorporated by reference in its entirety.

This invention is related to a method for making ophthalmic lenses (including contact lenses and intraocular lenses) being UV absorbing or not and having a hydrophilic surface but a reduced uptake of cationic compounds, e.g. from care solutions. This invention also provides UV-absorbing or not UV-absorbing ophthalmic lenses made according to a method of the invention.

### BACKGROUND

The key of the coating process of contact lenses made from silicone hydrogels is to render the hydrophobic surface hydrophilic by an appropriate coating process. It is known to render the surface of silicone hydrogel contact lenses hydrophilic by a treatment of the lenses in an alcoholic solution of poly acrylic acid (PAA) or poly methacrylic acid (PMAA) or other poly carboxylic acids, modified with additional functionalities, e.g. a photoinitiator for post reactions. As the so created hydrophilic surfaces are susceptible for the adherence of deposits they usually have to be modified by a second coating in a second coating step which makes the devices more resistant against deposits. Patent application WO 2014/095690 describes a process in which PAA is modified with a photoinitiator and the treated lenses are subsequently illuminated in an aqueous solution of a reactive polymer by UV light. During the illumination step the reactive polymer forms a new outer coating layer which is more robust and less susceptible for the adherence of deposits. Lenses produced by this process are ideal for a one-time usage, or in other words as a “one-day contact lens”, but not for a contact lens which is worn for several days or for many days (“daily wear”). The reason is that for this latter type of contact lenses a periodical treatment with care solutions between several wearing periods is necessary. These care solutions usually contain cationic charged compounds like Polyquad (PQ) or Poly(hexamethylene biguanide hydrochloride) (PHMB) as active ingredients. During treatment with these care solutions compounds such as PQ or PHMB diffuse into the lens interface or even into the bulk and form complexes with negatively charged/polarized functionalities of the coating or the bulk material. The ingredients of the care solution now bound to the contact lens could be released again during subsequent wearing of said contact lens and thereby can cause adverse events in the eye of a human contact lens wearer.

Therefore, there still exists a need for a method for making ophthalmic lenses, in particular contact lenses, even more preferred silicone contact lenses for daily wear, i.e. for lenses which require lens care between days on which they are worn.

These obstacles can be surprisingly resolved by a variation of the method disclosed in WO2014/095690 by which variation the access of cationic or basic ingredients from lens care solutions such as PQ or PHMB to the carboxylate functionalities of the coating are reduced by a complexation of the carboxylate functionalities with a fixed counter ion which is incorporated during the coating process.

### SUMMARY

In one aspect, the invention provides a method for producing contact lenses, comprising the steps of: obtaining a contact lens; dipping the contact lens in a coating solution comprising an organic solvent and a UV-absorbing polymer for a period of time sufficient to form a coating on the contact lens; wherein the UV-absorbing polymer comprises a) UV-absorbing monomeric units, b) covalently bound radical-initiating moieties, c) and at least about 50%, preferably at least about 60%, more preferably at least about 70%, even more preferably at least about 80%, most preferably at least about 90%, by mole of carboxyl-containing monomeric units; and irradiating the contact lens after the dipping step to obtain a photo-induced grafting of the polymer to the contact lens, in the presence of a hydrophilic vinylic monomer or crosslinker and in the presence of an amino-C2-4-alkyl (meth)acrylamide or an C1-4 alkyl-amino-C2-4-alkyl (meth)acrylamide to form a graft polymer on a contact lens which has a reduction of uptake of cationic compound as comparing to the contact lens prior to the coating treatment.

In another aspect the invention provides a contact lens, the lens comprising a polymeric lens body; a layer of UV-absorbing or not UV-absorbing polymer on the lens body; wherein the UV-absorbing polymer comprises UV-absorbing monomeric units, covalently bound radical-initiating moieties, and at least about 50%, preferably at least about 60%, more preferably at least about 70%, even more preferably at least about 80%, most preferably at least about 90%, by mole of carboxyl-containing monomeric units, wherein the layer of UV-absorbing or not UV-absorbing polymer is grafted to the lens body by a photo induced grafting process in the presence of a hydrophilic vinylic monomer or crosslinker and in the presence of an amino-C2-4-alkyl (meth)acrylamide or an C1-4 alkyl-amino-C2-4-alkyl (meth)acrylamide.

The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DETAILED DESCRIPTION

Before the present methods are disclosed and described, it is to be understood that the aspects described below are not limited to specific compounds, steps, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

It must be noted that, as used in the specification and the appended claims, the singular forms “a,” “an” and “the” include plural referents unless the context clearly dictates otherwise. Thus, for example, reference to “a monomer” includes mixtures of two or more such monomers, and the like.

“About” as used herein means that a number referred to as “about” comprises the recited number plus or minus 1-10% of that recited number.

“Optional” or “optionally” means that the subsequently described event or circumstance can or cannot occur, and that the description includes instances where the event or circumstance occurs and instances where it does not.

Unless defined otherwise, all technical and scientific terms used herein have the same meaning as commonly understood by one of ordinary skill in the art to which this invention belongs. As employed throughout the disclosure, the following terms, unless otherwise indicated, shall be understood to have the following meanings.

An “ophthalmic lens” refers to a contact lens and/or an intraocular lens. A “contact lens” refers to a structure that can be placed on or within a wearer's eye. A contact lens can correct, improve, or alter a user's eyesight, but that need not be the case. A “silicone hydrogel contact lens” refers to a contact lens comprising a silicone hydrogel material.

As used in this application, the term “hydrogel” or “hydrogel material” refers to a crosslinked polymeric material which is not water-soluble and can contain at least 10% by weight of water within its polymer matrix when fully hydrated.

A “silicone hydrogel” refers to a hydrogel containing silicone. A silicone hydrogel typically is obtained by copolymerization of a polymerizable composition comprising at least one silicone-containing vinylic monomer or at least one silicone-containing vinylic macromer or at least one silicone-containing prepolymer having ethylenically unsaturated groups.

A “vinylic monomer” refers to a compound that has one sole ethylenically-unsaturated group.

The term “olefinically unsaturated group” or “ethylenically unsaturated group” is employed herein in a broad sense and is intended to encompass any groups containing at least one >C═C< group. Exemplary ethylenically unsaturated groups include without limitation (meth)acryloyl

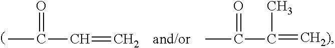

allyl, vinyl

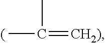

styrenyl, or other C═C containing groups.

The term “(meth)acrylamide” refers to methacrylamide and/or acrylamide.

The term “(meth)acrylate” refers to methacrylate and/or acrylate.

A “hydrophilic vinylic monomer”, as used herein, refers to a vinylic monomer which can be polymerized to form a homopolymer that is water-soluble or can absorb at least 10 percent by weight of water.

A “hydrophobic vinylic monomer” refers to a vinylic monomer which can be polymerized to form a homopolymer that is insoluble in water and can absorb less than 10 percent by weight of water.

As used in this application, the term “macromer” or “prepolymer” refers to a medium and high molecular weight compound or polymer that contains two or more ethylenically unsaturated groups. Medium and high molecular weight typically means average molecular weights greater than 700 Daltons.

As used in this application, the term “crosslinker” refers to a compound having at least two ethylenically unsaturated groups. A “crosslinking agent” refers to a crosslinker having a molecular weight of about 700 Daltons or less.

As used in this application, the term “polymer” means a material formed by polymerizing/crosslinking one or more monomers or macromers or prepolymers.

As used in this application, the term “molecular weight” of a polymeric material (including monomeric or macromeric materials) refers to the weight-average molecular weight unless otherwise specifically noted or unless testing conditions indicate otherwise.

The molecular weight of a UV absorbing polymer of the invention can vary broadly. It can be from about 3000 to about 700.000, preferably from about 5000 to about 500.000.

The term “soluble”, in reference to a compound or material in a solvent, means that the compound or material can be dissolved in the solvent to give a solution with a concentration of at least about 1% by weight at room temperature (i.e., a temperature of about 20° C. to about 30° C.).

The term “insoluble”, in reference to a compound or material in a solvent, means that the compound or material can be dissolved in the solvent to give a solution with a concentration of less than 0.005% by weight at room temperature (as defined above).

The term “water-soluble” in reference to a polymer means that the polymer can be dissolved in water to an extent sufficient to form an aqueous solution of the polymer having a concentration of at least about 1% by weight at room temperature (defined above).

As used in this application, the term “water contact angle” refers to an average water contact angle (i.e., contact angles measured by Sessile Drop method), which is obtained by averaging measurements of contact angles.

As used in this application, the term “crosslinked coating” or “hydrogel coating” interchangeably is used to describe a crosslinked polymeric material having a three-dimensional network that can contain water when fully hydrated. The three-dimensional network of a crosslinked polymeric material can be formed by crosslinking of two or more linear or branched polymers through crosslinkages.

“Polymer” means a material formed by crosslinking or polymerizing one or more monomers.

The invention is generally directed to a cost-effective and time-efficient method for making ophthalmic lenses, in particular, contact lenses. The method involves a simple dipping process to apply a coating onto a contact lens posterior to molding. The invention utilizes the fact that a layer (or coating) of a polymer with carboxyl groups can be easily applied onto a cast-molded contact lens just by dipping the contact lens in a solution of the polymer. The thickness and durability of the coating can be controlled by using an organic solvent as the solvent or one of the solvent mixture in the polymer solution and then rinsing with water or a mixture of water and at least one organic solvent. It is believed that when a solvent system containing at least one organic solvent is used for preparing a coating solution, it can swell a contact lens so that a portion of the polymer may penetrate into the contact lens and increase the thickness of the coating. The subsequent water-rinsing step can shrink the contact lens and embed partially the polymer and increase the durability of the coating. The coating may or may not comprise UV-absorbing moieties such that the resulting coating is or is not a UV-absorbing coating.

As also known from WO2014/095690, the durability of the coating is further improved by the polymer comprising, in addition to carboxyl-containing monomeric units, covalently bound radical-initiating moieties. The presence of these radical-initiating moieties allow a photo induced grafting (i.e., covalently attaching through the remaining residues of those radical-initiating moieties) of the coating onto the ophthalmic lens in the presence of a hydrophilic vinylic monomer or crosslinker. Such grafting can be achieved by irradiating the ophthalmic lens after the dipping step, in the presence of a hydrophilic vinylic monomer or crosslinker.

The method of this invention is directed to conduct the photo-induced grafting step by irradiation in the presence of an amino-C2-4-alkyl (meth)acrylamide or an C1-4 alkyl-amino-C2-4-alkyl (meth)acrylamide.

The method of the invention, in short, comprises a dipping step and an irradiation step wherein in the irradiation step an amino-C2-4-alkyl (meth)acrylamide or an C1-4 alkyl-amino-C2-4-alkyl (meth)acrylamide is used.

The method of the invention may also, in similar shortness, comprise a rinsing step between the dipping step and the irradiation step. The rinsing step is preferably conducted by rinsing with water.

The method of the invention may also, in similar shortness, comprise a rinsing step, an exposure to an amino-C2-4-alkyl (meth)acrylamide or an C1-4 alkyl-amino-C2-4-alkyl (meth)acrylamide in aqueous solution, and a further rinsing step between the dipping step and the irradiation step.

Contact lenses treated by any of the methods of the invention may then be extracted as usual, packed in a solution in packaging shells, closed with an appropriate foil and sterilized by autoclaving.

The present invention can provide the following advantages. First, the whole process is based on wet chemistry (dipping ophthalmic lenses in a solution for a period of time). Such process can be easily implemented in a fully-automated, mass-production environment. Second, the process for incorporating UV-absorbers can, if desired, be an integral part of a coating process for applying a hydrogel coating onto a contact lens. Third, the process including the photo-induced grafting step grafts the polymer to the ophthalmic lens. This has the effect of reducing or preventing a remigration (i.e., leaching) of the polymer from the ophthalmic lens into a solution in which the lens is stored. In other words the UV-absorbing polymer is better fixed to the ophthalmic lens than without the grafting step. Fourth, because of the mandatory presence of an amino-C2-4-alkyl (meth)acrylamide or an C1-4 alkyl-amino-C2-4-alkyl (meth)acrylamide during the irradiation step, there are amino groups present in the final coating. Said amino groups are complexing the carboxylate functionalities of the coating to a certain degree such that the uptake of basic ingredients from lens care solutions, such as PQ or PHMB, is reduced. This is of lower significance for silicone contact lenses having a carboxylate comprising coating which are worn only for a single day, but it is of significant importance for silicone contact lenses having a carboxylate comprising coating which are worn for “daily wear”. The reason is the potential uptake of ingredients of lens care solutions such as PQ or PHMB which can be reduced if amino groups are present in the coating.

In one aspect, the invention provides method for producing contact lenses, comprising the steps of: obtaining a contact lens; dipping the contact lens in a coating solution comprising an organic solvent and a UV-absorbing polymer for a period of time sufficient to form a coating on the contact lens; wherein the UV-absorbing polymer comprises a) UV-absorbing monomeric units, b) covalently bound radical-initiating moieties, c) and at least about 50%, preferably at least about 60%, more preferably at least about 70%, even more preferably at least about 80%, most preferably at least about 90%, by mole of carboxyl-containing monomeric units; and irradiating the contact lens after the dipping step to obtain a photo-induced grafting of the polymer to the contact lens, in the presence of a hydrophilic vinylic monomer or crosslinker and an in the presence of amino-C2-4-alkyl (meth)acrylamide or an C1-4 alkyl-amino-C2-4-alkyl (meth)acrylamide to form a graft polymer on a contact lens which has a reduction of uptake of cationic compound as comparing to the contact lens prior to the coating treatment.

In accordance with the invention, a contact lens can be any contact lens, including soft and hard contact lens. A preferred soft contact lens is a silicone hydrogel contact lens. An even more preferred contact lens is a silicone hydrogel contact lens for daily wear.

A person skilled in the art will know well how to make contact lenses. For example, contact lenses can be produced in a conventional “spin-casting mold,” as described for example in U.S. Pat. No. 3,408,429, or by the full cast-molding process in a static form, as described in U.S. Pat. Nos. 4,347,198; 5,508,317; 5,583,463; 5,789,464; and 5,849,810, or by lathe cutting of silicone hydrogel buttons as used in making customized contact lenses. In cast-molding, a lens formulation typically is dispensed into molds and cured (i.e., polymerized and/or crosslinked) in molds for making contact lenses. For production of preferred silicone hydrogel contact lenses, a lens formulation for cast-molding of contact lenses generally comprises at least one component selected from the group consisting of a silicone-containing vinylic monomer, a silicone-containing vinylic macromer, a hydrophilic vinylic monomer, a hydrophilic vinylic macromer, a hydrophobic vinylic monomer, and combinations thereof. It must be understood that a lens-forming composition can also comprise various components, such as, for example, a crosslinking agent, a visibility tinting agent (e.g., dyes, pigments, or mixtures thereof), antimicrobial agents (e.g., preferably silver nanoparticles), a bioactive agent, leachable lubricants, leachable tear-stabilizing agents, and mixtures thereof, as known to a person skilled in the art. Resultant silicone hydrogel contact lenses then can be subjected to extraction with an extraction solvent to remove unpolymerized components from the resultant lenses and to hydration process, as known by a person skilled in the art. In addition, a contact lens can be a colored contact lens (i.e., a contact lens having at least one colored pattern printed thereon as well known to a person skilled in the art).

A person skilled in the art knows very well how to prepare a lens formulation. Numerous non-silicone hydrogel lens formulation and silicone hydrogel lens formulations have been described in numerous patents and patent applications published by the filing date of this application. All of them can be used in obtaining a contact lens. A silicone hydrogel lens formulation for making commercial silicone hydrogel contact lenses, such as lotrafilcon A, lotrafilcon B, balafilcon A, galyfilcon A, senofilcon A, narafilcon A, narafilcon B, comfilcon A, enfilcon A, asmofilcon A, filcon II 3, can also be used in making silicone hydrogel contact lenses which then can be used to make UV-absorbing contact lenses according to a method of the invention.

Lens molds for making contact lenses are well known to a person skilled in the art and, for example, are employed in cast molding or spin casting. For example, a mold (for cast molding) generally comprises at least two mold sections (or portions) or mold halves, i.e. first and second mold halves. The first mold half defines a first molding (or optical) surface and the second mold half defines a second molding (or optical) surface. The first and second mold halves are configured to receive each other such that a lens forming cavity is formed between the first molding surface and the second molding surface. The molding surface of a mold half is the cavity-forming surface of the mold and in direct contact with lens-forming material.

Methods of manufacturing mold sections for cast-molding a contact lens are generally well known to those of ordinary skill in the art. The process of the present invention is not limited to any particular method of forming a mold. In fact, any method of forming a mold can be used in the present invention. The first and second mold halves can be formed through various techniques, such as injection molding or lathing. Examples of suitable processes for forming the mold halves are disclosed in U.S. Pat. No. 4,444,711 to Schad; U.S. Pat. No. 4,460,534 to Boehm et al.; U.S. Pat. No. 5,843,346 to Morrill; and U.S. Pat. No. 5,894,002 to Boneberger et al. (which are also incorporated by reference herewith).

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, N.J.), or the like can be used. Other materials that allow UV light transmission could be used, such as quartz glass and sapphire.

In accordance with the invention, a UV-absorbing polymer comprises UV-absorbing monomeric units, covalently bound radical-initiating moieties, and at least about 50%, preferably at least about 60%, more preferably at least about 70%, even more preferably at least about 80%, most preferably at least about 90%, by mole of carboxyl-containing monomeric units. Each UV-absorbing monomeric unit comprises a UV-absorbing moiety which can be benzotriazole-moiety, benzophenone-moiety or triazine moiety, with benzotriazole-moiety or benzophenone-moiety as preferred UV-absorbing moiety, with benzotriazole-moiety as most preferred UV-absorbing moiety. As used in this application, the term “monomeric units” refers to repeating units of a polymer, which are derived from a vinylic monomer participated in a polymerization and optionally can be modified by a compound after polymerization.

Each covalently bound radical-initiating moiety introduced into a UV-absorbing or not UV-absorbing polymer by using a functionalized radical-initiating compound suitable to be bound to carboxy groups of a precursor polymer or an intermediary UV-absorbing or not UV-absorbing polymer. Functionalized radical-initiating compounds suitable to be bound to carboxy are known and described, for example, in WO 03/042724, WO 86/005778, EP-B 632 329 and EP-B 800 511. Preferred radical-initiating compounds are those of the Irgacure type.

A UV-absorbing or not UV-absorbing polymer of the invention can be obtained from an intermediary UV-absorbing or not UV-absorbing polymer obtained by copolymerizing a polymerizable mixture comprising at least one carboxyl-containing vinylic monomer and (or not) at least one UV-absorbing vinylic monomer in the presence or absence of a vinylic monomer, provided that the carboxyl-containing vinylic monomer is present in an amount of at least about 50%, preferably at least about 60%, more preferably at least about 70%, even more preferably at least about 80%, most preferably at least about 90% by mole in the polymerizable composition.

An intermediary UV-absorbing or not UV-absorbing polymer so obtained can be further modified to include covalently bound radical-initiating moieties by reacting it with a functionalized radical-initiating compound in a coupling reaction, e.g. with an Irgacure type photoinitiator via the active ester route with N-(3-dimethylaminopropyl)-N′-ethylcarbo-diimid. Other “coupling reactions” described hereinafter can be used likewise to attach a functionalized radical-initiating compound to the intermediary UV-absorbing or not UV-absorbing polymer.

Any UV-absorbing vinylic monomers can be used in the preparation of an intermediary UV-absorbing polymer of the invention. Examples of preferred UV-absorbing vinylic monomers include without limitation benzotriazole-containing vinylic monomers (e.g., 2-(2-hydroxy-5-vinylphenyl)-2H-benzotriazole, 2-(2-hydroxy-5-acrylyloxyphenyl)-2H-benzotriazole, 2-(2-hydroxy-3-methacrylamido methyl-5-tert octylphenyl) benzotriazole, 2-(2′-hydroxy-5′-methacrylamido-phenyl)-5-chlorobenzotriazole, 2-(2′-hydroxy-5′-methacrylamidophenyl)-5-methoxybenzo-triazole, 2-(2′-hydroxy-5′-methacryloxypropyl-3′-t-butyl-phenyl)-5-chlorobenzotriazole, 2-(2′-hydroxy-5′-methacryloxyethylphenyl) benzotriazole, 2-(2′-hydroxy-5′-methacryloxypropyl-phenyl) benzotriazole, or combination thereof); benzophenone-containing vinyl monomers (e.g., 2-hydroxy-4-acryloxy alkoxy benzophenone, 2-hydroxy-4-methacryloxy alkoxy benzophenone, allyl-2-hydroxybenzophenone, and 2-hydroxy-4-methacryloxy benzophenone, or combinations thereof); or combination thereof. Benzotriazole-containing vinyl monomers can be prepared according to procedures described in U.S. Pat. Nos. 3,299,173, 4,612,358, 4,716,234, 4,528,311 (herein incorporated by reference in their entireties) or can be obtained from commercial suppliers. Benzophenone-containing vinyl monomers can be prepared according to procedures described in U.S. Pat. No. 3,162,676 (herein incorporated by reference in its entirety) or can be obtained from commercial suppliers.

Any functionalized radical-initiating compound suitable to be bound to carboxy group can be used in the preparation of the UV-absorbing or not UV-absorbing polymer of the invention. A functionalized radical-initiating compound suitable to be bound to carboxy group comprises a group which is co-reactive to a carboxy group, such as amino or hydroxy group, preferably amino group. The radical-initiating part may belong to different types, for example to the thioxanthone type and preferably to the benzoin type.

In a preferred embodiment of the invention the covalent bonding between carboxy groups and the functionalized radical-initiating compound occurs via reaction of a carboxy group with a hydroxyl, amino or alkylamino group of the radical-initiating compound, for example by using a radical-initiating compound of formula (10a) of EP B1 1299753 which is incorporated by reference in relevant part. The reaction of carboxy groups with hydroxyl or amino groups of a radical-initiating compound of, for example formula 10a of EP B1 1299753 is well-known in the art and may be carried out, for example, as described in textbooks of organic chemistry.

Any suitable carboxyl-containing vinylic monomers can be used in the preparation of an intermediary UV-absorbing or not UV-absorbing polymer of the invention. Examples of preferred carboxyl-containing vinylic monomers include without limitation acrylic acid, C₁-C₁₂ alkylacrylic acid (e.g., methacrylic acid, ethylacrylic acid, propylacrylic acid, butylacrylic acid, pentylacrylic acid, etc.), N,N-2-acrylamidoglycolic acid, beta-methyl-acrylic acid (crotonic acid), alpha-phenyl acrylic acid, beta-acryloxy propionic acid, sorbic acid, angelic acid, cinnamic acid, 1-carobxy-4-phenyl butadiene-1,3, itaconic acid, citraconic acid, mesaconic acid, glutaconic acid, aconitic acid, maleic acid, fumaric acid, tricarboxy ethylene, and combinations thereof. A UV-absorbing or not UV-absorbing polymer is prepared from at least one carboxyl-containing vinylic monomer selected from the group preferably consisting of acrylic acid, methacrylic acid, ethylacrylic acid, propylacrylic acid, butylacrylic acid, pentylacrylic acid, and combinations thereof, more preferably consisting of acrylic acid, methacrylic acid, ethylacrylic acid, propylacrylic acid, and combinations thereof, even more preferably consisting of acrylic acid, methacrylic acid, ethylacrylic acid, and combinations thereof.

Alternatively, a UV-absorbing polymer of the invention can be obtained by sequentially (in no particular order) reacting a UV-absorbing compound and a radical-initiating compound or by reacting a mixture of a UV-absorbing compound and a radical-initiating compound, with (i.e., covalently attaching UV-absorbing moieties to) a precursor polymer having at least about 50%, preferably at least about 60%, more preferably at least about 70%, even more preferably at least about 80%, most preferably at least about 90%, by mole of carboxyl-containing monomeric units in a coupling reaction known to a person skilled in the art.

A “coupling reaction” is intended to describe any reaction between a pair of matching functional groups in the presence or absence of a coupling agent to form covalent bonds or linkages under various reaction conditions well known to a person skilled in the art, such as, for example, oxidation-reduction conditions, dehydration condensation conditions, addition conditions, substitution (or displacement) conditions, Diels-Alder reaction conditions, cationic crosslinking conditions, ring-opening conditions, epoxy hardening conditions, and combinations thereof. Non-limiting examples of coupling reactions under various reaction conditions between a pair of matching co-reactive functional groups selected from the group preferably consisting of amino group (—NHR′ as defined above), hydroxyl group, carboxylic acid group, acid halide groups (—COX, X═Cl, Br, or I), acid anhydrate group, aldehyde group, azlactone group, isocyanate group, epoxy group, aziridine group, thiol group, and amide groups (—CONH₂), are given below for illustrative purposes. A carboxylic acid group reacts with an amino group —NHR′ in the presence of a coupling agent—carbodiimide (e.g., 1-ethyl-3-(3-dimethylaminopropyl) carbodiimide (EDC), N,N′-dicyclohexylcarbodiimide (DCC), 1-cylcohexyl-3-(2-morpholinoethyl)carbodiimide, diisopropyl carbodiimide, or mixtures thereof) to form an amide linkage; a carboxylic acid group reacts with an isocyanate group under heating to form an amide linkage; a carboxyl group reacts with an epoxy or aziridine group to form an ester bond; a carboxyl group reacts with a halide group (—Cl, —Br or —I) to form an ester bond; an amino group reacts with aldehyde group to form a Schiff base which may further be reduced; an amino group —NHR′ reacts with an acid chloride or bromide group or with an acid anhydride group to form an amide linkage (—CO—NR′—); an amino group —NHR′ reacts with an isocyanate group to form a urea linkage (—NR′—C(O)—NH—); an amino group —NHR′ reacts with an epoxy or aziridine group to form an amine bond (C—NR′); an amino group reacts (ring-opening) with an azlactone group to form a linkage (—C(O)NH—CR₁R₂—(CH₂)ᵣ—C(O)—NR′—); a hydroxyl reacts with an isocyanate to form a urethane linkage; a hydroxyl reacts with an epoxy or aziridine to form an ether linkage (—O—); a hydroxyl reacts with an acid chloride or bromide group or with an acid anhydride group to form an ester linkage; an hydroxyl group reacts with an azlactone group in the presence of a catalyst to form a linkage (—C(O)NH—CR₁R₂—(CH₂)ᵣ—C(O)—O—); a thiol group (—SH) reacts with an isocyanate to form a thiocarbamate linkage (—N—C(O)—S—); a thiol group reacts with an epoxy or aziridine to form a thioether linkage (—S—); a thiol group reacts with an acid chloride or bromide group or with an acid anhydride group to form a thiolester linkage; a thiol group reacts with an azlactone group in the presence of a catalyst to form a linkage (—C(O)NH-alkylene-C(O)—S—); a thiol group reacts with a vinyl group based on thiol-ene reaction under thiol-ene reaction conditions to form a thioether linkage (—S—); and a thiol group reacts with an acryloyl or methacryloyl group based on Michael Addition under appropriate reaction conditions to form a thioether linkage.

It is also understood that coupling agents with two reactive functional groups may be used in the coupling reactions. For example, a diisocyanate, di-acid halide, di-carboxylic acid, di-azlactone, or di-epoxy compound can be used in the coupling of two hydroxyl, two amino groups, two carboxyl groups, two epoxy groups, or combination thereof; a diamine or dihydroxyl compound can be used in the coupling of two isocyanate, two epoxy, two aziridine, two carboxyl, two acid halide, or two azlactone groups, or combinations thereof.

The reactions conditions for the above described coupling reactions are taught in textbooks and are well known to a person skilled in the art.

Any polymer comprising at least about 50%, preferably at least about 60%, more preferably at least about 70%, even more preferably at least about 80%, most preferably at least about 90%, by mole of carboxyl-containing monomeric units can be used as precursor polymer in the preparation of a UV-absorbing or not UV-absorbing polymer of the invention. Preferably, a precursor polymer is: a homopolymer of a carboxyl-containing vinylic monomer (acrylic acid or C₁-C₁₂ alkylacrylic acid); a copolymer of acrylic acid and C₁-C₁₂ alkylacrylic acid; a copolymer of a carboxyl-containing vinylic monomer (acrylic acid or C₁-C₁₂ alkylacrylic acid) and an amino-containing vinylic monomer (e.g., amino-C₂-C₆ alkyl (meth)acrylate, C₁-C₆ alkylamino-C₂-C₆ alkyl (meth)acrylate, allylamine, vinylamine, amino-C₂-C₆ alkyl (meth)acrylamide, C₁-C₆ alkylamino-C₂-C₆ alkyl (meth)acrylamide); a copolymer of a carboxyl-containing vinylic monomer (acrylic acid or C₁-C₁₂ alkylacrylic acid) and one or more hydrophilic vinylic monomers being free of carboxyl or amino group and selected from the group consisting of acrylamide (AAm), methacrylamide N,N-dimethylacrylamide (DMA), N,N-dimethyl methacrylamide (DMMA), N-vinylpyrrolidone (NVP), N,N,-dimethylaminoethylmethacrylate (DMAEM), N,N-dimethylaminoethylacrylate (DMAEA), N,N-dimethylaminopropyl methacrylamide (DMAPMAm), N,N-dimethylaminopropylacrylamide (DMAPAAm), glycerol methacrylate, 3-acryloylamino-1-propanol, N-hydroxyethyl acrylamide, N-[tris(hydroxymethyl) methyl]-acrylamide, N-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 2-hydroxyethyl (meth)acrylate, hydroxypropyl (meth)acrylate, C₁-C₄-alkoxy polyethylene glycol (meth)acrylate having a weight average molecular weight of up to 1500 Daltons, N-vinyl formamide, N-vinyl acetamide, N-vinyl isopropylamide, N-vinyl-N-methyl acetamide, allyl alcohol, vinyl alcohol (hydrolyzed form of vinyl acetate in the copolymer), and combinations thereof. More preferably, a precursor polymer is polyacrylic acid, polymethacrylic acid, poly(C₂-C₁₂ alkylacrylic acid), poly(acrylic acid-co-methacrylic acid), poly[C₂-C₁₂ alkylacrylic acid-co-(meth)acrylic acid], poly(N,N-2-acrylamidoglycolic acid), poly[(meth)acrylic acid-co-acrylamide], poly[(meth)acrylic acid-co-vinylpyrrolidone], poly[C₂-C₁₂ alkylacrylic acid-co-acrylamide], poly[C₂-C₁₂ alkylacrylic acid-co-vinylpyrrolidone], hydrolyzed poly[(meth)acrylic acid-co-vinylacetate], hydrolyzed poly[C₂-C₁₂ alkylacrylic acid-co-vinylacetate], or combinations thereof.

Any UV-absorbing compounds, which comprise UV-absorbing moieties and a reactive functional group selected from the group consisting of amino group, azlactone group, epoxy group, isocyanate group, aziridine group, and combination thereof, can be used in the invention. A preferred UV-absorbing compound having a benzotriazole-moiety, which can be used in the invention, is represented by formula I, II, or III

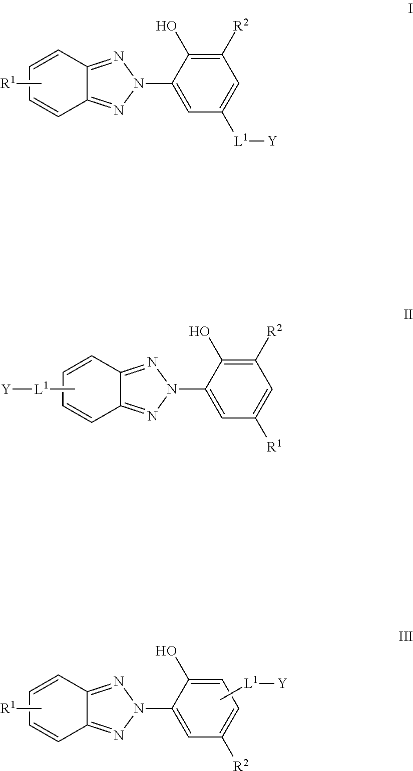

wherein:

R¹ and R² independently of each other are hydrogen, a C₁-C₁₂ linear or branched alkyl group, a halogen (Cl or Br), a C₆ to C₂₄ aryl group, a C₇ to C₂₄ alkylaryl group, a C₇ to C₂₄ arylalkyl, or a C₁-C₁₂ linear or branched alkoxy group;

L¹ is a covalent bond or a divalent radical of —Xₐ-E₁-X_{b}-E₂-X_{c}— in which Xₐ is a covalent bond, —O—, carbonyl

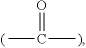

a divalent radical of —(R^{a}O)ₙ— in which R^{a} is a linear or branched C₁-C₁₂-alkylene and n is from 1 to 10,

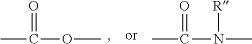

in which R″ is H or C₁-C₈ alkyl, E₁ and E₂ independently of each other are a covalent bond, a divalent radical of —(R^{a}O)ₙ— in which R^{a} and n are defined above,

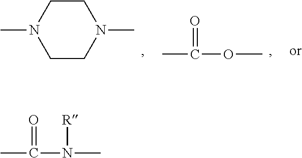

in which R″ is H or C₁-C₈ alkyl, a C₁ to C₁₂ linear or branched alkylene divalent radical, a cycloalkyl divalent radical with up to 40 carbon atoms, an alkylcycloalkyl divalent radical with up to 40 carbon atoms, an alkylaryl divalent radical with up to 40 carbon atoms, an arylalkylene divalent radical with up to 40 carbon atoms, or a dicarbonyl group having the formula —C(O)L²C(O)— in which L² is a C₁ to C₁₂ linear or branched alkylene divalent radical or —(R^{e1}—O)_{w1}—(R^{e2}—O)_{w2}—(R^{e3}—O)_{w3}—, wherein R^{e1}, R^{e2}, and R^{e3} independently of one another are a linear or branched C₁-C₄-alkylene and w1, w2 and w3 independently of one another are a number from 0 to 20 provided that the sum of (n+m+p) is 1 to 60, and X_{b} and X_{c} independently of each other are a covalent bond, carbonyl,

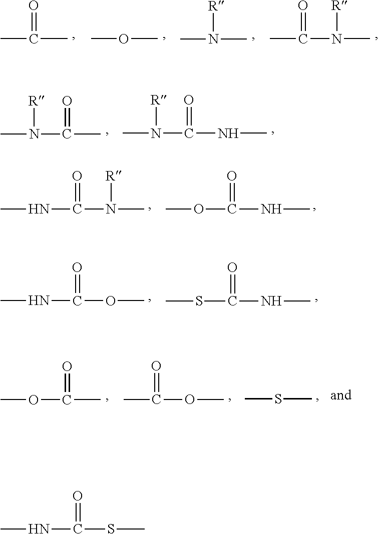

in which R″ is defined above; and

Y is an azlactone group, an epoxy group, an isocyanate group, an aziridine group, or an amino group of —NHR′ in which R′ is hydrogen or a C₁-C₁₂ unsubstituted or substituted, linear or branched alkyl group.

Examples of amino-containing UV-absorbing compounds of formula I, II or III include without limitation 2-(2′-hydroxy-3′-aminomethyl-5′-methylphenyl)-2H-benzotriazole, 2-(2′-hydroxy-5′-aminophenyl)-2H-benzotriazole, 2-(2′-hydroxy-4′-(3-aminopropoxy)phenyl)-2H-benzotriazole, 2-(2′-hydroxy-4′-ethylaminophenyl)-5-chloro-benzotriazole. Alternatively, amino-containing UV-absorbing compounds of formula I, II, or III can be prepared from a benzotriazole-containing vinyl monomer (any one of those described above) by reacting its ethylenically-unsaturated group with an aminomercaptan (e.g., 2-aminoethanethiol) according to Michael Addition or thiol-ene reaction well known to a person skilled in the art.

UV-absorbing compounds of formula I, II or III in which Y is an azlactone group, an epoxy group, or an isocyanate group can be prepared from a benzotriazole compound having one hydroxyalkoxy group or an amino group by reacting it with an excess molar equivalent amount of a di-azlactone compound, a di-epoxy compound, or a di-isocyanate compound under customary coupling reaction condition well known to a person skilled in the art.

Examples of di-epoxy compounds are neopentyl glycol diglycidyl ether, 1,6-hexanediol diglycidyl ether, ethylene glycol diglycidyl ether, diethylene glycol diglycidyl ether, polyethylene glycol diglycidyl ether, propylene glycol diglycidyl ether, and dipropylene glycol diglycidyl ether. Such di-epoxy compounds are available commercially (e.g., those DENACOL series di-epoxy compounds from Nagase ChemteX Corporation). Examples of C₁₀-C₂₄ di-azlactone compounds include those described in U.S. Pat. No. 4,485,236 (herein incorporated by reference in its entirety). Examples of C₄-C₂₄ diisocyanates can be used in the invention. Diisocyanates include without limitation isophorone diisocyanate, hexamethyl-1,6-diisocyanate, 4,4′-dicyclohexylmethane diisocyanate, toluene diisocyanate, 4,4′-diphenyl diisocyanate, 4,4′-diphenylmethane diisocyanate, p-phenylene diisocyanate, 1,4-phenylene 4,4′-diphenyl diisocyanate, 1,3-bis-(4,4′-isocyanto methyl) cyclohexane, cyclohexane diisocyanate, and combinations thereof.

In formula I, II or Ill, Y preferably is an amino group of —NHR′ in which R′ is hydrogen or a C₁-C₁₂ unsubstituted or substituted, linear or branched alkyl group.

A preferred UV-absorbing compound having a benzophenone-moiety, which can be used in the invention, is represented by formula IV

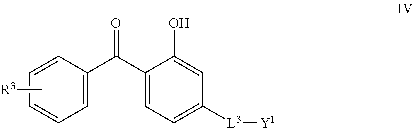

in which

R³ is hydrogen, a C₁-C₁₂ linear or branched alkyl group, a halogen, a C6 to C₂₄ aryl group, a C₇ to C₂₄ alkylaryl group, a C₇ to C₂₄ arylalkyl, or a C₁-C₁₂ linear or branched alkoxy group;

L³ is a covalent bond or a divalent radical of —Xₐ-E₁-X_{b}-E₂-X_{c}— in which Xₐ is a covalent bond, —O—, carbonyl

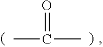

a divalent radical of —(R^{a}O)ₙ— in which R^{a} is a linear or branched C₁-C₁₂-alkylene and n is from 1 to 10,

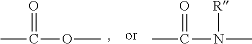

in which R″ is H or C₁-C₈ alkyl, E₁ and E₂ independently of each other are a covalent bond, a divalent radical of —(R^{a}O)ₙ— in which R^{a} and n are defined above,

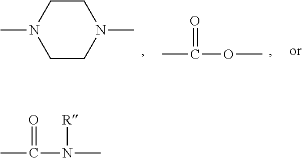

in which R″ is H or C₁-C₈ alkyl, a C₁ to C₁₂ linear or branched alkylene divalent radical, a cycloalkyl divalent radical with up to 40 carbon atoms, an alkylcycloalkyl divalent radical with up to 40 carbon atoms, an alkylaryl divalent radical with up to 40 carbon atoms, an arylalkylene divalent radical with up to 40 carbon atoms, or a dicarbonyl group having the formula —C(O)L²C(O)— in which L² is a C₁ to C₁₂ linear or branched alkylene divalent radical or —(R^{e1}—O)_{w1}—(R^{e2}—O)_{w2}—(R^{e3}—O)_{w3}—, wherein R^{e1}, R^{e2}, and R^{e3} independently of one another are a linear or branched C₁-C₄-alkylene and w1, w2 and w3 independently of one another are a number from 0 to 20 provided that the sum of (n+m+p) is 1 to 60, and X_{b} and X_{c} independently of each other are a covalent bond, carbonyl,

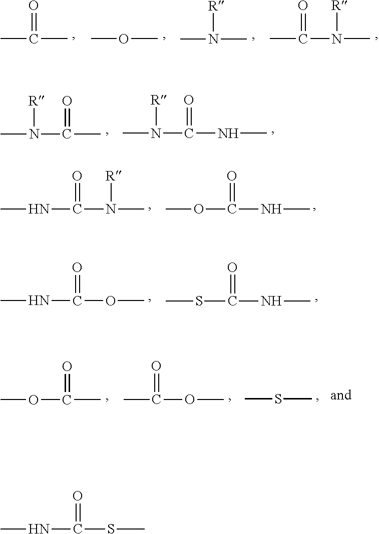

in which R″ is defined above; and

Y¹ is an azlactone group, an epoxy group, an isocyanate group, an aziridine group, or an amino group of —NHR in which R is hydrogen or a C₁-C₁₂ unsubstituted or substituted, linear or branched alkyl group.

In formula IV, Y¹ preferably is an amino group of —NHR in which R is hydrogen or a C₁-C₂₀ unsubstituted or substituted, linear or branched alkyl group.

Amino-containing UV-absorbing compounds of formula IV can be prepared from a benzophenone-containing vinyl monomer by reacting its ethylenically-unsaturated group with an aminomercaptan (e.g., 2-aminoethanethiol) according to Michael Addition or thiol-ene reaction well known to a person skilled in the art. Resultants amino-containing UV-absorbing compounds of formula IV then can be used directly in the invention or in preparing UV-absorbing compounds of formula IV in which Y¹ is an azlactone group, an epoxy group, or an isocyanate group, by reacting an amino-containing UV-absorbing compounds of formula IV with an excess molar equivalent amount of a di-azlactone compound, a di-epoxy compound, or a di-isocyanate compound under customary coupling reaction condition well known to a person skilled in the art.

In a preferred embodiment, the UV-absorbing compound comprises one or more compounds of formula I, II, III or IV, preferably of formula I, II or III, in which Y and Y¹ is an amino group of —NHR′ in which R′ is hydrogen or a C₁-C₁₂ unsubstituted or substituted, linear or branched alkyl group, R¹ and R² independent of each other is hydrogen, halogen, C₁-C₆ linear or branched alkoxy, C₁-C₁₂ linear or branched alkyl (preferably t-butyl), or C₆-C₁₅ aryl, L is a covalent bond or a divalent radical of —Xₐ-E₁-X_{b}-E₂-X_{c}— in which Xₐ is a covalent bond or —O—,

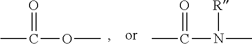

in which R″ is H or C₁-C₈ alkyl, E₁ and E₂ independently of each other are a covalent bond, a divalent radical of —(R^{a}O)ₙ— in which R^{a} is a linear or branched C₁-C₁₂-alkylene and n is from 1 to 10, a C₁ to C₁₂ linear or branched alkylene divalent radical, a cycloalkyl divalent radical with up to 12 carbon atoms, an alkylcycloalkyl divalent radical with up to 20 carbon atoms, an alkylphenyl divalent radical with up to 20 carbon atoms, or an phenylalkylene divalent radical with up to 20 carbon atoms, X_{b} and X_{c} independently of each other are a covalent bond, carbonyl,

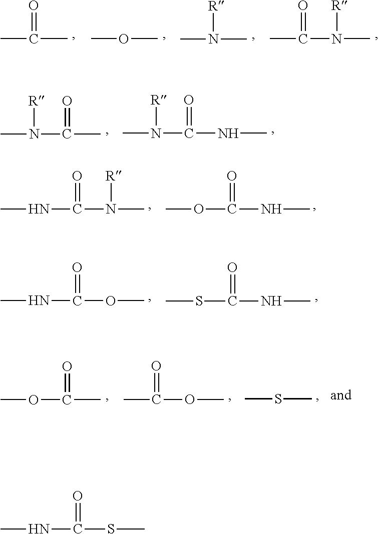

in which R″ is defined above; and Y is an amino group of —NHR in which R is hydrogen or a C₁-C₆ unsubstituted or substituted, linear or branched alkyl group.

A preferred embodiment of an intermediary UV-absorbing polymer is a copolymer of acrylic acid or methacrylic acid with a UV-absorbing vinylic monomer, preferably comprising structural units of the following formula

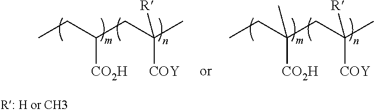

wherein Y is the radical of a UV-absorbing moiety, the total of (m+n) is an integer from 21 to 10000, and the ratio of m:n is from 200:1 to 20:1.

In any given UV-absorbing polymer of the invention the covalently bound radical-initiating moieties are present in the UV-absorbing polymer preferably from about 3 to about 15 mole percent, more preferably from about 5 to about 10 mole percent.

In any given UV-absorbing polymer of the invention the UV-absorbing monomeric units are present in the UV-absorbing polymer preferably from about 4 to about 15 mole percent, more preferably from about 5 to 12 mole percent.

In any given UV-absorbing polymer of the invention the ratio of UV-absorbing monomeric units to covalently bound radical-initiating moieties is from 100:1 to 1:100, preferably from 10:1 to 1:10, while at the same time the mole percent of carboxyl-containing units is at least about 50%, preferably at least about 60%, more preferably at least about 70%, even more preferably at least about 80%, most preferably at least about 90%.

A solution of a UV-absorbing polymer for forming a UV-absorbing layer (coating) on contact lenses can be prepared by dissolving one or more UV-absorbing polymers in water, a mixture of water and one or more organic solvents miscible with water, an organic solvent, or a mixture of one or more organic solvent. Examples of preferred organic solvents include without limitation, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimethyl ether, polyethylene glycols, polypropylene glycols, ethyl acetate, butyl acetate, amyl acetate, methyl lactate, ethyl lactate, iso-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof.

Preferably, the UV-absorbing or not UV-absorbing polymers are dissolved in a mixture of water and one or more organic solvents, an organic solvent, or a mixture of one or more organic solvent. It is believed that a solvent system containing at least one organic solvent can swell a contact lens so that a portion of the UV-absorbing or not UV-absorbing polymer may penetrate into the contact lens and increase the thickness and durability of the UV-absorbing or not UV-absorbing coating. Any organic solvents described above can be used in preparation of a solution of the UV-absorbing or not UV-absorbing polymer, so long as it can dissolve the UV-absorbing or not UV-absorbing polymer.

Contacting of a contact lens with a solution of a UV-absorbing or not UV-absorbing polymer can be carried out in any manner known to a person skilled in the art. A preferred contact method is dipping a contact lens in the solution or spraying the contact with the solution, with the former being preferred. It is understood that, before contacting with a solution of a UV-absorbing or not UV-absorbing polymer, a contact lens can be subjected to extraction with an extraction solvent to remove unpolymerized components from the molded lens, as known by a person skilled in the art. Alternatively, extraction step can be carried out after a coating (layer) of the UV-absorbing or not UV-absorbing polymer is applied onto the contact lens.

In a preferred embodiment, the organic solvent is present in an amount of at least about 60%, preferably at least about 70%, more preferably at least about 80%, even more preferably at least about 90%, most preferably at least about 95% by weight in the coating solution, and the method of the invention further comprises a step of rinsing the ophthalmic lens having the UV-absorbing coating thereon with a mixture of water and at most about 50%, preferably at most about 40%, more preferably at most about 30%, even more preferably at most about 20%, most preferably at most about 10% by weight of an organic solvent.

The grafting process can be initiated, for example, thermally by the action of heat or preferably by irradiation, particularly by UV radiation. Suitable light sources for the irradiation are know to the artisan and comprise for example mercury lamps, high-pressure mercury lamps, xenon lamps, carbon arc lamps or sunlight. The time period of irradiation may depend for example on the desired properties of the resulting ophthalmic lens but is usually in the range of up to 30 minutes, preferably from 10 seconds to 10 minutes, and particularly preferably from 0.5 to 5 minutes. It is advantageous to carry out the irradiation in an atmosphere of inert gas. The irradiation can also be performed in solution, for example in a PBS solution of pH 7.0. A suitable lamp is a Hamamatsu light source used for about 5 minutes with an intensity of about 4 to 6 mW/cm2. After grafting any non-covalently bonded polymers, oligomers or non-reacted macromonomers formed can be removed, for example by treatment with suitable solvent.

Nearly any hydrophilic vinylic monomer can be used in the invention. Suitable hydrophilic vinylic monomers are, without this being an exhaustive list, (meth)acrylamide, di-alkyl(C₁ to C₆) (meth)acrylamide, (C₁ to C₆) alkyl (meth)acrylamide, hydroxyl-substituted lower alkyl (C₁ to C₆) (meth)acrylamide, hydroxyl-substituted lower alkyl (C₁ to C₆) (meth)acrylates, hydroxyl-substituted lower alkyl vinyl ethers, N-vinylpyrrole, N-vinyl-2-pyrrolidone, 2-vinyloxazoline, 2-vinyl-4,4′-dialkyloxazolin-5-one, 2- and 4-vinylpyridine, olefinically unsaturated carboxylic acids having a total of 3 to 6 carbon atoms, amino(lower alkyl)-(where the term “amino” also includes quaternary ammonium), mono(lower alkylamino)(lower alkyl) and di(lower alkylamino)(lower alkyl)acrylates and methacrylates, allyl alcohol, N-vinyl alkylamide, N-vinyl-N-alkylamide, and the like.

Preferred hydrophilic vinylic monomers are N,N-dimethylacrylamide (DMA), N,N-dimethylmethacrylamide (DMMA), 2-acrylamidoglycolic acid monohydrate, 3-acryloylamino-1-propanol, N-hydroxyethyl acrylamide, N-[tris(hydroxymethyl)methyl]-acrylamide, N-methyl-3-methylene-2-pyrrolidone, 2-hydroxyethylmethacrylate (HEMA), 2-hydroxyethyl acrylate (HEA), hydroxypropyl acrylate, hydroxypropyl methacrylate (HPMA), trimethylammonium 2-hydroxy propylmethacrylate hydrochloride, aminopropyl methacrylate hydrochloride, dimethylamino-ethyl methacrylate (DMAEMA), glycerol methacrylate (GMA), N-vinyl-2-pyrrolidone (NVP), allyl alcohol, vinylpyridine, acrylic acid, a C₁-C₄-alkoxy polyethylene glycol (meth)acrylate having a weight average molecular weight of from 200 to 1500, for example poly(ethylene glycol)-methylether methacrylate, methacrylic acid, N-vinyl formamide, N-vinyl acetamide, N-vinyl isopropylamide, N-vinyl-N-methyl acetamide, allyl alcohol, N-vinyl caprolactam, and mixtures thereof.

The grafting step can further be conducted in the presence of a hydrophilic vinylic monomer and a crosslinker, or in the presence of a crosslinker alone, as long as the crosslinker is hydrophilic. Such crosslinker has at least two ethylenically unsaturated groups, and can be a crosslinking agent (i.e., a compound comprising two or more ethylenically unsaturated groups and having a molecular weight of 700 daltons or less).

Examples of hydrophilic vinylic monomer and preferred such monomers have been provided hereinbefore. Especially preferred is a C₁-C₄-alkoxy polyethylene glycol (meth)acrylate having a weight average molecular weight of from 200 to 1500, for example poly(ethylene glycol)-methylether methacrylate.

Examples of preferred crosslinking agents include without limitation tetra(ethyleneglycol) diacrylate, tri(ethyleneglycol) diacrylate, ethyleneglycol diacrylate, di(ethyleneglycol) diacrylate, tetraethyleneglycol dimethacrylate, triethyleneglycol dimethacrylate, ethyleneglycol dimethacylate, di(ethyleneglycol) dimethacrylate, trimethylopropane trimethacrylate, penta-erythritol tetramethacrylate, bisphenol A dimethacrylate, vinyl methacrylate, ethylene-diamine dimethylacrylamide, glycerol dimethacrylate, triallyl isocyanurate, triallyl cyanurate, allylmethacrylate, dimers (e.g., 1,3-bis(methacrylamidopropyl)-1, 1,3,3-tetrakis(trimethyl-siloxy)disiloxane, 1,3-bis(N-methacrylamidopropyl)-1, 1,3,3-tetrakis-(trimethylsiloxy)disiloxane, 1,3-bis(methacrylamidobutyl)-1,1,3,3-tetrakis(trimethylsiloxy)-disiloxane, 1,3-bis(acrylamide-propyl)-1,1,3,3-tetrakis(trimethylsiloxy)disiloxane, 1,3-bis(methacryloxyethylureidopropyl)-1,1,3,3-tetrakis(trimethylsiloxy)disiloxane) disclosed in U.S. Pat. No. 4,711,943 (herein incorporated by reference in its entirety), an acrylamide-modified polyvinylalcohol, for example as disclosed in WO02/071106 and exemplified herein, and combinations thereof. Preferred cross-linking agents are poly(ethyleneglycol) diacrylate, tetra(ethyleneglycol) diacrylate, tri(ethyleneglycol) diacrylate, ethyleneglycol diacrylate, di(ethyleneglycol) diacrylate, triallyl isocyanurate, or triallyl cyanurate. An even more preferred crosslinking agent is poly(ethyleneglycol) diacrylate (Mn about 700 Da, Aldrich #455008) and an acrylamide-modified polyvinylalcohol, for example as disclosed in example 2 of WO02/071106.

In order to obtain the desired effect of the invention, namely to mask the carboxylate functionalities of the coating by complexation, such that uptake of basic or cationic compounds is reduced, the irradiation step to obtain a photo-induced grafting is conducted in the additional presence (additional to the hydrophilic vinylic monomer or crosslinker) of an amino-C2-4-alkyl (meth)acrylamide or an C1-4 alkyl-amino-C2-4-alkyl (meth)acrylamide.

Said amino-C2-4-alkyl (meth)acrylamide or C1-4 alkyl-amino-C2-4-alkyl (meth)acrylamide are preferably an amino-C2-4-alkyl acrylamide or an amino-C2-4-alkyl methacrylamide while an C1-4 alkyl amino-C2-4-alkyl acrylamide or an C1-4 alkyl-amino-C2-4-alkyl methacrylamide can also be used.

Preferred individual compounds are amino-ethyl-methacrylamide, amino-ethyl-acrylamide, amino-propyl-methacrylamide, amino-propyl-acrylamide, amino-butyl-methacrylamide, and amino-butyl-acrylamide. Of those is amino-propyl-methacrylamide particularly preferred, even more particularly N(3-amino-propyl)-methacrylamide (typically abbreviated APMAA).

A compound selected from amino-C2-4-alkyl (meth)acrylamide and C1-4 alkyl-amino-C2-4-alkyl (meth)acrylamide can be applied in aqueous solution in a concentration between 1% by weight and 10% by weight, preferably between 2% by weight and 6% by weight. This applies independently from using such a compound in the final irradiation step only or also in an additional step between the dipping step and the irradiation step.

In accordance with the invention, heating is performed preferably by autoclaving a contact lens with the coating thereon in a packaging solution (i.e., a buffered aqueous solution) including a water-soluble thermally crosslinkable hydrophilic polymeric material in a sealed lens package at a temperature of from about 118° C. to about 125° C. for approximately 20-90 minutes. In accordance with this embodiment of the invention, the packaging solution is a buffered aqueous solution which is ophthalmically safe after autoclave. Alternatively, it is performed preferably by autoclaving a contact lens, which comprises a coating immersed in a packaging solution (i.e., a buffered aqueous solution) in a sealed lens package at a temperature of from about 118° C. to about 125° C. for approximately 20-90 minutes.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes) prior to dispensing to users. A person skilled in the art will understand well how to seal and sterilize lens packages.

In accordance with the invention, a packaging solution contains at least one buffering agent to maintain a pH of the packaging solution in a physiologically acceptable range of about 6 to about 8.5, one or more other tonicity agents to provide a tonicity of from about 200 to about 450 milliosmol (mOsm), preferably from about 250 to about 350 mOsm, and other ingredients known to a person skilled in the art. Examples of other ingredients include without limitation, surfactants/lubricants, antibacterial agents, preservatives, and/or water-soluble viscosity builders (e.g., cellulose derivatives, polyvinyl alcohol, polyvinylpyrrolidone).

Examples of physiologically compatible buffering agents are boric acid, borates, e.g. sodium borate, citric acid, citrates, e.g. potassium citrate, bicarbonates, e.g. sodium bicarbonate, TRIS (2-amino-2-hydroxymethyl-1,3-propanediol), Bis-Tris (Bis-(2-hydroxyethyl)-imino-tris-(hydroxymethyl)-methane), bis-aminopolyols, triethanolamine, ACES (N-(2-hydroxyethyl)-2-aminoethanesulfonic acid), BES (N,N-Bis(2-hydroxyethyl)-2-aminoethanesulfonic acid), HEPES (4-(2-hydroxyethyl)-1-piperazineethanesulfonic acid), MES (2-(N-morpholino)ethanesulfonic acid), MOPS (3-[N-morpholino]-propanesulfonic acid), PIPES (piperazine-N,N′-bis(2-ethanesulfonic acid), TES (N-[Tris(hydroxymethyl)methyl]-2-aminoethanesulfonic acid), salts thereof, phosphate buffers, e.g. Na₂HPO₄, NaH₂PO₄, and KH₂PO₄ or mixtures thereof. A preferred bis-aminopolyol is 1,3-bis(tris[hydroxymethyl]-methylamino)propane (bis-TRIS-propane). The amount of each buffer agent in a packaging solution is preferably from 0.001% to 2%, preferably from 0.01% to 1%; most preferably from about 0.05% to about 0.30% by weight.

Suitable ocularly acceptable tonicity agents include, but are not limited to sodium chloride, potassium chloride, glycerol, propylene glycol, polyols, mannitols, sorbitol, xylitol and mixtures thereof.

A packaging solution of the invention has a viscosity of from about 1 centipoise to about 20 centipoises, preferably from about 1.2 centipoises to about 10 centipoises, more preferably from about 1.5 centipoises to about 5 centipoises, at 25° C.

In a preferred embodiment, a method of the invention further comprises a step of dipping the contact lens in a solution of blue light-absorbing polymer having blue light-absorbing monomeric units and at least about 50%, preferably at least about 60%, more preferably at least about 70%, even more preferably at least about 80%, most preferably at least about 90%, by mole of carboxyl-containing monomeric units. The term “blue light-absorbing monomeric units” refers to repeating units of a polymer each of which comprises a blue light-absorbing moiety. A “blue light-absorbing moiety” refers to an organic group which can render a compound containing such group to absorb light in the region of from about 400 nm to about 480 nm. One preferred blue light-absorbing moiety is nitrophenylpyrrolidine group. A blue light absorbing polymer can be prepared according to procedures similar to those described above for UV-absorbing polymers. For example, a blue light-absorbing polymer can be prepared by polymerizing a polymerizable mixture comprising at least one carboxyl-containing vinylic monomer (any one of those described above) and at least one blue light-absorbing vinylic monomer, or alternatively by reacting a blue light-absorbing compound having a reactive functional group (e.g., amino group, azlactone group, epoxy group, isocyanate group, aziridine group, and combination thereof, with amino groups as most preferred reactive functional groups) with a precursor polymer (any one of those described above for preparing UV-absorbing polymers) containing carboxyl and optional amino groups.

In another preferred embodiment, a contact lens, preferably a silicone hydrogel contact lens obtained according to a method of the invention has a surface wettability characterized by having an averaged water contact angle of about 90 degrees or less, preferably about 80 degrees or less, more preferably about 70 degrees or less, even more preferably about 60 degrees or less, most preferably about 50 degrees or less.

It should be understood that although in this aspect of the invention various embodiments including preferred embodiments of the invention may be separately described above, they can be combined and/or used together in any desirable fashion to arrive at different embodiments of a contact lenses of the invention.

In another aspect, the invention provides an ophthalmic lens, the lens comprising a polymeric lens body; a layer of UV-absorbing or not UV-absorbing polymer on the lens body; and a hydrogel grafted onto the layer of the UV-absorbing or not UV-absorbing polymer, wherein the UV-absorbing or not UV-absorbing polymer comprises UV-absorbing monomeric units or no such units and at least about 50%, preferably at least about 60%, more preferably at least about 70%, even more preferably at least about 80%, most preferably at least about 90%, by mole of carboxyl-containing monomeric units, wherein the hydrogel graft is obtained by a photo induced grafting process made possible by irradiating the covalently bound radical-initiating moieties in the presence of a hydrophilic vinylic monomer or crosslinker and of an amino-C2-4-alkyl (meth)acrylamide or an C1-4 alkyl-amino-C2-4-alkyl (meth)acrylamide.

All of the various embodiments as described above for the previous aspect of the invention can be used, alone or in any combination, in this aspect of the invention.

The previous disclosure will enable one having ordinary skill in the art to practice the invention. Various modifications, variations, and combinations can be made to the various embodiment described herein. In order to better enable the reader to understand specific embodiments and the advantages thereof, reference to the following examples is suggested. It is intended that the specification and examples be considered as exemplary.

Although various aspects and various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part or can be combined in any manner and/or used together. Therefore, the spirit and scope of the appended claims should not be limited to the description of the preferred versions contained therein.

### Examples: General Remarks

Oxygen Permeability Measurements

The apparent oxygen permeability of a lens and oxygen transmissibility of a lens material is determined according to a technique similar to the one described in U.S. Pat. No. 5,760,100 and in an article by Winterton et al., (The Cornea: Transactions of the World Congress on the Cornea 111, H. D. Cavanagh Ed., Raven Press: New York 1988, pp 273-280), both of which are herein incorporated by reference in their entireties. Oxygen fluxes (J) are measured at 34° C. in a wet cell (i.e., gas streams are maintained at about 100% relative humidity) using a Dk1000 instrument (available from Applied Design and Development Co., Norcross, Ga.), or similar analytical instrument. An air stream, having a known percentage of oxygen (e.g., 21%), is passed across one side of the lens at a rate of about 10 to 20 cm³/min., while a nitrogen stream is passed on the opposite side of the lens at a rate of about 10 to 20 cm³/min. A sample is equilibrated in a test media (i.e., saline or distilled water) at the prescribed test temperature for at least 30 minutes prior to measurement but not more than 45 minutes. Any test media used as the overlayer is equilibrated at the prescribed test temperature for at least 30 minutes prior to measurement but not more than 45 minutes. The stir motor's speed is set to 1200±50 rpm, corresponding to an indicated setting of 400±15 on the stepper motor controller. The barometric pressure surrounding the system, P_{measured}, is measured. The thickness (t) of the lens in the area being exposed for testing is determined by measuring about 10 locations with a Mitotoya micrometer VL-50, or similar instrument, and averaging the measurements. The oxygen concentration in the nitrogen stream (i.e., oxygen which diffuses through the lens) is measured using the DK1000 instrument. The apparent oxygen permeability of the lens material, Dkₐₚₚ, is determined from the following formula:

Dkₐₚₚ=Jt/(P_{oxygen})

where J=oxygen flux [microliters O₂/cm²-minute]

P_{oxygen}=(P_{measured}−P_{water} vapor)=(% O₂ in air stream) [mm Hg]=partial pressure of oxygen in the air stream

P_{measured}=barometric pressure (mm Hg)

P_{water} vapor=0 mm Hg at 34° C. (in a dry cell) (mm Hg)

P_{water} vapor=40 mm Hg at 34° C. (in a wet cell) (mm Hg)

t=average thickness of the lens over the exposed test area (mm)

Dkₐₚₚ is expressed in units of barrers.

The apparent oxygen transmissibility (Dk/t) of the material may be calculated by dividing the apparent oxygen permeability (Dkₐₚₚ) by the average thickness (t) of the lens.

The above described measurements are not corrected for the so-called boundary layer effect which is attributable to the use of a water or saline bath on top of the contact lens during the oxygen flux measurement. The boundary layer effect causes the reported value for the apparent Dk of a silicone hydrogel material to be lower than the actual intrinsic Dk value. Further, the relative impact of the boundary layer effect is greater for thinner lenses than with thicker lenses. The net effect is that the reported Dk appear to change as a function of lens thickness when it should remain constant.

The intrinsic Dk value of a lens can be estimated based on a Dk value corrected for the surface resistance to oxygen flux caused by the boundary layer effect as follows.

Measure the apparent oxygen permeability values (single point) of the reference lotrafilcon A (Focus® N&D® from CIBA VISION CORPORATION) or lotrafilcon B (AirOptix™ from CIBA VISION CORPORATION) lenses using the same equipment. The reference lenses are of similar optical power as the test lenses and are measured concurrently with the test lenses.

Measure the oxygen flux through a thickness series of lotrafilcon A or lotrafilcon B (reference) lenses using the same equipment according to the procedure for apparent Dk measurements described above, to obtain the intrinsic Dk value (Dki) of the reference lens. A thickness series should cover a thickness range of approximately 100 μm or more. Preferably, the range of reference lens thicknesses will bracket the test lens thicknesses. The Dkₐₚₚ of these reference lenses must be measured on the same equipment as the test lenses and should ideally be measured contemporaneously with the test lenses. The equipment setup and measurement parameters should be held constant throughout the experiment. The individual samples may be measured multiple times if desired.

Determine the residual oxygen resistance value, Rᵣ, from the reference lens results using equation 1 in the calculations.

$${R}_{r} = \frac{\sum ( \frac{t}{{Dk}_{app}} - \frac{t}{{Dk}_{i}} )}{n} \qquad ( 1 )$$

in which t is the thickness of the test lens (i.e., the reference lens too), and n is the number of the reference lenses measured. Plot the residual oxygen resistance value, Rᵣ vs. t data and fit a curve of the form Y=a+bX where, for the jth lens, Yⱼ=(ΔP/J)ⱼ and X=tⱼ. The residual oxygen resistance, Rᵣ is equal to a.

Use the residual oxygen resistance value determined above to calculate the correct oxygen permeability Dk_{c} (estimated intrinsic Dk) for the test lenses based on Equation 2.

Dk_{c}=t/[(t/Dkₐ)−Rᵣ] (2)

The estimated intrinsic Dk of the test lens can be used to calculate what the apparent Dk (Dkₐ_{_}_{std}) would have been for a standard thickness lens in the same test environment based on Equation 3. The standard thickness (t_{std}) for lotrafilcon A=85 μm. The standard thickness for lotrafilcon B=60 μm.

Dkₐ_{_}_{std}=t_{std}/[(t_{std}/Dk_{c})+Rᵣ_{_}_{std}] (3)

Ion Permeability Measurements.

The ion permeability of a lens is measured according to procedures described in U.S. Pat. No. 5,760,100 (herein incorporated by reference in its entirety. The values of ion permeability reported in the following examples are relative ionoflux diffusion coefficients (D/D_{ref}) in reference to a lens material, Alsacon, as reference material. Alsacon has an ionoflux diffusion coefficient of 0.314×10⁻³ mm²/minute.

Surface Wettability Tests.

Water contact angle on a contact lens is a general measure of the surface wettability of the contact lens. In particular, a low water contact angle corresponds to more wettable surface. Average contact angles (Sessile Drop) of contact lenses are measured using a VCA 2500 XE contact angle measurement device from AST, Inc., located in Boston, Mass. This equipment is capable of measuring advancing or receding contact angles or sessile (static) contact angles. The measurements are performed on fully hydrated contact lenses and immediately after blot-drying as follows. A contact lens is removed from the vial and washed 3 times in ˜200 ml of fresh DI water in order to remove loosely bound packaging additives from the lens surface. The lens is then placed on top of a lint-free clean cloth (Alpha Wipe TX1009), dabbed well to remove surface water, mounted on the contact angle measurement pedestal, blown dry with a blast of dry air and finally the sessile drop contact angle is automatically measured using the software provided by the manufacturer. The DI water used for measuring the contact angle has a resistivity >18MΩcm and the droplet volume used is 2 μl. Typically, uncoated silicone hydrogel lenses (after autoclave) have a sessile drop contact angle around 120 degrees. The tweezers and the pedestal are washed well with Isopropanol and rinsed with DI water before coming in contact with the contact lenses.

Coating Intactness Tests.

The intactness of a hydrophilic coating on the surface of a contact lens can be tested according to Sudan Black stain test as follow. Contact lenses with a hydrophilic coating (an LbL coating, a plasma coating, or any other coatings) are dipped into a Sudan Black dye solution (Sudan Black in vitamin E oil) and then rinsed extensively in water. Sudan Black dye is hydrophobic and has a great tendency to be absorbed by a hydrophobic material or onto a hydrophobic lens surface or hydrophobic spots on a partially coated surface of a hydrophobic lens (e.g., silicone hydrogel contact lens). If the hydrophilic coating on a hydrophobic lens is intact, no staining spots should be observed on or in the lens. All of the lenses under test are fully hydrated. If a contact lens under test has a hydrophobic lens surface or hydrophobic spots on a partially coated surface of a hydrophobic lens, the contact lens is stained or staining spots can be observed on or in the lens.

Tests of Coating Durability.

The lenses are digitally rubbed with Solo-Care® multi-purpose lens care solution for 30 times and then rinsed with saline. The above procedure is repeated for a given times, e.g., from 1 to 30 times, (i.e., number of consecutive digital rubbing tests which imitate cleaning and soaking cycles). The lenses are then subjected to Sudan Black test (i.e., coating intactness test described above) to examine whether the hydrophilic coating is still intact. To survive digital rubbing test, there is no significantly increased staining spots (e.g., staining spots covering no more than about 5% of the total lens surface). Water contact angles are measured to determine the coating durability.

Other Instrumentation:

1H-NMR spectroscopic investigations are performed with a Bruker Avance 400 NMR spectrometer. For UV-Vis spectroscopic studies a Perkin Elmer Lambda 25 spectrometer is utilized. Lens spectra are recorded in a quartz cuvette (length: 1 cm) in a PBS solution (pH=7.0). The spectra of the package solutions are recorded as taken out of the package in quartz cuvettes (length also 1 cm).

Reduction of Uptake of Cationic/Basic Substances (TPO Uptake Test):

The success and performance of the method is demonstrated by an assay with Toluidine Blue O (TPO) as a modelling compound for active ingredients like PQ or PHMB of lens care solutions. TPO is a cationic charged dye which acts quantitatively with carboxylate functionalities. TPO or chemical analogues thereof were used in several studies for UV- or fluorescence spectroscopic determination of carboxylate functionalities on interfaces (S. Rödiger et al., Anal. Chem., 83 (2011), 3379), V. B. Ivanov et al., Surf. and Interface Anal., 24 (1996), 257).

In this assay for the determination of bound TPO (TPO uptake) lenses are immersed for 30 minutes in an aqueous solution of TPO (c=50 ppm) at 50° C. and pH=10. Then the lenses are treated for 30 minutes in a 35° C. warm aqueous buffer solution (pH=10) for washing off excess, not bound dye. Then the intensely coloured lens is transferred into 50° C. warm acidified buffer solution (pH=2) for the release of bound TPO. After a treatment time of 30 minutes it is visually checked whether the lens is still coloured or not. If the lens is still coloured the TPO releasing procedure is repeated as long as the lens becomes colourless—usually after 2 or 3 repetitions of the relevant steps. The TPO released into the buffer solutions is then analysed quantitatively at a wavelength of 630 nm by UV-vis spectroscopy. The TPO released is a direct measurement of the TPO uptake from the solutions into which the lenses are immersed.

### Example 1

### Contact Lenses:

In the examples herein uncoated Delefilcon A contact lenses are used. Preparation of the underlying polydimethyl siloxane macromer, of the lens formulation and of the contact lens as such are described e.g. in WO 2014/095690, example 1. Cast molded lenses are demolded and used in the examples hereinafter as “unextracted Delefilcon A contact lenses”.

### Example 2

### Preparation of Poly(Acrylic Acid-Co-Norbloc) (PAA-N20).

A UV-absorbing polymer of formula (2) (in which m:n˜90:10), designated as PAA-N20, has a molecular weight of about 14.6 kD and comprises about 11.1 by mole of UV-absorbing monomeric units (Norbloc, [3-(2-H-Benzotriazol-2-yl)-4-hydroxyphenyl]ethyl methacrylate). It is prepared according to the procedures described below.

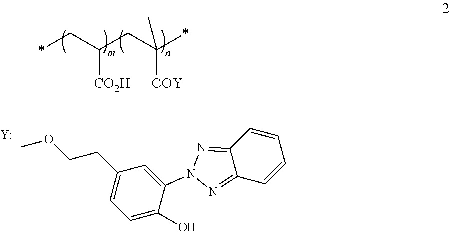

Into a 550 ml three-neck flask equipped with a N2-inlet tube, a condenser, a thermometer and a magnetic bar are placed a mixture of 8.04 g acrylic acid (112 mmol; Fluka #017309111), 2.18 g ([3-(2-H-benzotriazol-2-yl)-4-hydroxyphenyl]ethyl methacrylate (Norbloc 7966; 6.7 mmol; Aldrich #22,-705-6) and 200 ml of N,N-dimethylformamid (DMF; Aldrich, #227056). Through this solution nitrogen is conducted in order to free the solution from air. Then it is heated up to 60° C. while stirring and 2 ml of a DMF solution with 4% of dimethyl-2,2′-azobisisobutyrate (V-601, Wako #927-14717) is added. The reaction mixture is kept at 60° C. by stirring over a period of 16 h. Then approx. 150 mL of the solvent is destilled off in vacuum (0.01 mbar, 45° C.) and the remaining solution cooled down to ambient temperature and poured into 200 mL of ethyl acetate. The resulting precipitate is separated by centrifugation (6000 min⁻¹, 30 min), re-dissolved in a slightly basic aqueous solution (pH=10.0, adjusted with sodium carbonate) and ultrafiltrated (3 kDa membrane, Millipore # P2PLBCV01; 15×volume exchange by water) against de-ionized water. After freeze-drying of the solution 4.3 g of a white, solid product is isolated.

1H-NMR (400 MHz; D2O) δ: 0.8-3.15 (maxima at 1.06, 1.62, 1.82, 2.28, 2.62, 2.75), 4.12, 6.5-8.1 (H_{aromatic}) ppm; all signals are unstructured and broad.

The mole percentage of Norbloc monomeric units in copolymer PAA-N20 is X_{Norbloc}=11.1 (Mol-%), based on 1H-NMR integration according to the following equation

X_{Norbloc}[Mol-%]=100×[3×A_{aromatic}/(7×A₁−4×A_{aromatic})]

in which A₁ is the integral of the area of the protons between 1.02-3.15 ppm and A_{aromatic} is the integral of the area of the aromatic signals between 6.5-8.15 ppm.

UV-Vis absorbance (PBS solution at pH 7.0): Two maxima with absorption coefficients ε₁ (300 nm)=13.64 and ε₂ (330 nm)=13.51 [l/(g×cm)].

Molecular weight by GPC (PSS Suprema columns with 30 Å and 1000 Å pore size; PBS solution as eluent; Na-Poly (acrylic acid) as calibration standards): Mw=14 kDa

### Example 3

### Preparation of PAA-N20-Irg:

1.00 g (14 mmol) PAA-N20 (Mw=14 kD; prepared according to the example hereinbefore are dissolved in 75 ml water by stirring. To this solution are added at ambient temperature 2 ml each of an aqueous solution of 1-(3-Dimethylaminopropyl)-3-ethylcarbodiimid-hydrochlorid (w=22%, EDC-HCl; Fluka #03450), N-Hydroxysulfo-succinimid-Na salt (w=24%; NHS; Aldrich #341851) and after 15 min 1.48 g (5.7 mmol) of solid 2-hydroxy-2-methyl-1-[4-(2-hydroxethylamino) ethoxy] phenyl-1-propanone (Irgacure-amine; prepared according to WO 03/042724, example A-1, page 24). After the Irgacure-amine is completely dissolved the pH of the solution is adjusted to 9.0 by a 1 N aqueous NaOH solution. After 16 h the clear solution is neutralized with 1N hydrochloric acid, ultra filtrated (1 kD membrane, Millipore # P2PLACV01, 10×volume exchange by water) against de-ionized water and concentrated. After freeze-drying of the resulting solution 1.32 g of a white, solid material is isolated.

¹H-NMR (400 MHz, D₂O) δ: 0.9-2.6 (maxima at 1.00, 1.45, 1.61, 1.81, 2.11, 2.52), 2.81 (s; corresponds to EDC-HCl: —N(CH₃), 2.97-3.17, 3.23, 3.46, 3.77, 3.83, 3.9-4.3 (maxima at 4.20 and 4.27), 6.7-7.8 (maxima at 6.87 and 6.89, H_{aromatic}), 7.91 (d, corresponds to Irgacure-amin: H_{aromatic}).

1-H-NMR integration delivers the following composition for polymer PAA-N20-Irg: 64 mol-% repeating units with acrylic acid moieties, 14 mol-% with Norbloc, 14 mol-% with photoinitiator and 8 mol-% moieties with EDC as origin.

UV-Vis absorbance (PBS solution at pH 7.0): two maxima with absorption coefficients ε₁ (284 nm)=16.88 [l/(g×cm)] and ε₂ (330 nm)=8.84 [l/(g×cm)].

Molecular weight by GPC (PSS Suprema columns with 30 Å and 1000 Å pore size; PBS solution as eluent, Na—Polyacrylic acid as calibration standards): M_{w}=14.8 kD.

### Example 4

### Preparation of PAA-VDM:

6.49 g (90 mmol) acrylic acid and 3.73 g (10 mmol) 4-(2-hydroxy-2-methyl propanoyl)phenoxy ethyl 2-(2-propenyl-amino)-2-methyl propanoate [VDM; preparation: G. N. Babu et. al., ACS Polymer Preprints, 38 (1997), 510] together with 100 ml N,N-dimethylformamid (Sigma-Aldrich #227056) are placed in a flask. Through this solution argon is conducted in order to free the solution from air. Then it is heated up to 60° C. by stirring and 0.019 g (0.08 mmol) dimethyl-2,2′-azobisisobutyrate (V-601, Wako #927-14717) added. The reaction mixture is kept by stirring at 60° C. over a period of 20 h. Then 50 ml of the DMF is removed by vacuum distillation and the residual solution is poured in 200 ml ethyl acetate. The resulting precipitate is separated by centrifugation, re-dissolved in a slightly basic aqueous solution (pH=10.0, adjusted with sodium bicarbonate) and ultrafiltrated (1 kDa membrane, Millipore # P2PLACV01; 10×volume exchange by water) against de-ionized water. After freeze-drying of the solution 8.13 g of a white, solid material are isolated.

1-H-NMR (400 MHz, D2O) δ: 1.0-2.7 (maxima at 1.42, 1.53, 1.58, 2.09, 2.56), 4.0-4.6 (maxima at 4.25, 4.41, 4.55), 6.6-7.2 (corresponds to 2H_{aromatic} of VDM), 7.7-8.2 (corresponds to 2H_{aromatic} of VDM).

1-H-NMR integration delivers the following composition for polymer PAA-VDM: 91.3 mol-% with acrylic acid moieties, 8.7 mol-% with photoinitiator. Thus PAA-VDM can be characterized by the following formula 4

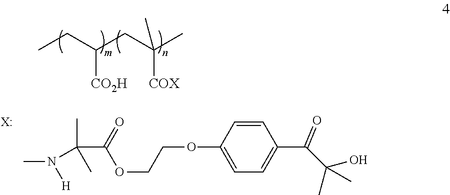

wherein the ratio of m:n is 91:9.

UV-Vis absorbance (PBS solution at pH 7.0): maxima with absorption coefficients ε₁ (280 nm)=9.71 [l/(g×cm)].

Molecular weight by GPC [PSS Suprema columns with 30 Å and 1000 Å pore size; PBS solution as eluent. Na-Polyacrylic acid as calibration standards): M_{w}=34 kD.

### Example 5

### Preparation of PAA-Irg 450:

To a solution of 2.01 g of poly acrylic acid (Mw=450 kD; Aldrich #18:128-5) in 100 mL water are added 2.1 mL of an aqueous solution of 1-(3-dimethyl amino propyl)-3-ethyl-carbodiimid-hydrochlorid (c=27.4%) and 2.1 mL of an aqueous solution of N-hydroxysulfosuccinimid-Na salt (c=29.6%). The solution is stirred with a magnetic bar at ambient temperature until all components are dissolved. Then 2.22 g of solid 2-hydroxy-2-methyl-1-[4-(2-hydroxethylamino) ethoxy] phenyl-1-propanone (Irgacure-amine; prepared according WO 03/042724, example A-1, page 24) are added and the pH of the solution adjusted to pH=9.0 by addition of an 1N aqueous solution of NaOH. After 16 h the clear solution is neutralized with a 1N aqueous solution of hydrochloric acid and ultrafiltrated (Millipore, 10 kD Pellicon membranes, art.# P2C010V01). After freeze drying 2.2 g of a white, solid product is isolated.

¹H-NMR (400 MHz, D₂O) δ: 0.9-2.6 (maxima at 1.05, 1.62, 1.90, 2.19), 2.84 (s; corresponds to EDC-HCl: —N(CH₃), 3.01-3.24, 3.32, 3.56, 3.88, 4.42, 7.08 (H_{aromatic}), 8.11 (H_{aromatic}).

1-H-NMR integration delivers the following composition for polymer PAA-Irg 450: 86 mol-% repeating units with acrylic acid moieties, 7 mol-% photoinitiator and 7 mol-% moieties with EDC as origin.

UV-Vis absorbance (PBS solution at pH 7.0): maxima with absorption coefficients ε(280 nm)=7.82 [l/(g×cm)].

### Example 6

### Manufacture of Dipping Solution and Dipping Process

### Dipping Solutions:

The PAA-N20 dipping solution is prepared by dissolving PAA-N20 (0.36%) in a mixture of 1-Propanol/water (4%) and acidification to pH=2 by addition of formic acid.

The PAA-N20-Irg dipping solution is prepared by dissolving of PAA-N20-Irg (0.36%) in ethanol and acidification of the solution to pH=2 by addition of an ethanolic solution of hydrochloric acid (Fluka #17934).

The PAA-VDM dipping solution is prepared by dissolving PAA-VDM (0.36%) in 1-Propanol and acidification of the solution to pH=2.0 by addition of an propanolic solution of hydrochloric acid (Fluka #17933).

The PAA-Irg 450 dipping solution is prepared by dissolving of PAA-Irg 450 (0.36%) in 1-propanol and acidification of the solution to pH=2.0 by addition of an propanolic solution of hydrochloric acid (Fluka #17933).

### Dipping Process:

Unextracted contact lenses of Example 1 lenses are placed in a holder and treated with the appropriate dipping solutions. The treatment is stopped after the lenses show in their UV spectrum (recorded in PBS solution) at 315 nm (local minimum) a UV absorbance (A) ≥2. The lenses are then rinsed with de-ionized water (6 min) and subsequently with a PBS solution (1 min).

### Example 7

### UV-Post Treatment Process of Lenses/Photo Induced Grafting:

All steps are performed under a N₂ atmosphere. Into a quartz cuvette with an unextracted contact lens of Example 1 treated with the appropriate dipping solutions according example 6 is poured the appropriate UV treatment solution (see hereinafter) (approximately 1.5 ml/lens). After 5 minutes the lens is illuminated for 5 minutes by two light wave guides, vertically arranged to the lens surface, but oppositely to each other with UV light (intensity: 5.8 mW/cm2 per light wave guide) from a Hamamatsu UV light source equipped with a 328 nm edge filter. Then the lens is taken out of the curing solution, rinsed with water, packed together with a PBS storage solution in a PP shell, closed by a foil and autoclaved.

As UV-treatment solutions are used i) a PBS solution (pH=7.0), ii) a PBS buffered (pH=7.0) aqueous solution of poly(ethylene glycol)-diacrylate (PEG-DA 700; 10%; Mₙ=700 D; Aldrich #455008, iii) a PBS buffered (pH=7.0) aqueous solution of poly(ethylene glycol)-methylether methacrylate (PEG-MEMA 950; 10%; Mₙ=950; Aldrich #447951) and iv) a PBS buffered (pH=7.0) aqueous solution of polyvinyl alcohol of formula 3 hereinafter (PVA; 9%; preparation according to example 2 in WO 02/071106) (named rPVA herein, e.g. in examples 8 to 11)

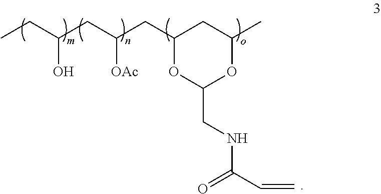

### Example 8

An un-extracted Delefilcon A contact lens is firstly immersed for 5 minutes in an acidified propanolic solution (pH=2.0) of PAA-N20-Irg of example 3 (Mw=14.8 kD; 14 mol-% Irgacure moieties, 14 mol-% Norbloc moieties), rinsed with water, immersed for 5 minutes in an aqueous solution of APMAA (26%), rinsed again with water and transferred into a PBS buffered solution of polyvinylalcohol rPVA (c=9%) (see example 7 iv herein) and APMAA (4%). There the lens is irradiated for 5 minutes from both lens sides with a Hamamatsu light source at an intensity of 2×5.8 mW/cm2. The irradiated lens is taken off the solution, washed with water, transferred into a packaging shell filled-up with a PBS solution and autoclaved.

### Example 9

An un-extracted Delefilcon A contact lens is firstly immersed for 44 seconds in an acidified propanolic solution (pH=2.0) of PAA-VDM of example 4 (Mw=34 kD; 8.7 mol-% Irgacure moieties), rinsed with water, immersed for 5 minutes in an aqueous solution of APMAA (3.6%), rinsed again with water and transferred into a PBS buffered solution of polyvinylalcohol rPVA (c=9%) and APMAA (4%). There the lens is irradiated for 5 minutes from both lens sides with a Hamamatsu light source at an intensity of 2×5.8 mW/cm2. The irradiated lens is taken off the solution, washed with water, transferred into a packaging shell filled-up with a PBS solution and autoclaved.

### Example 10 (Control Experiment)

An un-extracted Delefilcon A contact lens is firstly immersed for 44 seconds in an acidified propanolic solution (pH=2.0) of PAA-VDM of example 4 (Mw=34 kD; 8.7 mol-% Irgacure moieties), rinsed with water, and transferred into a PBS buffered solution of polyvinylalcohol rPVA (c=9%). There the lens is irradiated for 5 minutes from both lens sides with a Hamamatsu light source at an intensity of 2×5.8 mW/cm2. The irradiated lens is taken off the solution, washed with water, transferred into a packaging shell filled-up with a PBS solution and autoclaved.

### Example 11

An un-extracted Delefilcon A contact lens is firstly immersed for 44 seconds in an acidified propanolic solution (pH=2.0) of PAA-Irg450 of example 5 (Mw=450 kD; 7 mol-% Irgacure moieties), rinsed with water, and transferred into a PBS buffered solution of polyvinylalcohol rPVA (c=9%) and APMAA (4%). There the lens is irradiated for 2 minutes from both lens sides with a Hamamatsu light source at an intensity of 2×5.8 mW/cm2. The irradiated lens is taken off the solution, washed with water, transferred into a packaging shell filled-up with a PBS solution and autoclaved.

### Example 12 (Control Experiment)

An un-extracted Delefilcon A contact lens is firstly immersed for 44 seconds in an acidified propanolic solution (pH=2.0) of PAA-Irg450 of example 5 (Mw=450 kD; 7 mol-% Irgacure moieties), rinsed with water, and transferred into a packaging shell filled-up with a PBS solution and autoclaved.

### Example 13 (Comparison)

TPO uptake of an Air Optix Aqua contact lens from Alcon/Ciba Vision. The lenses are taken-off from a commercial package, rinsed with water and treated according to the described TPO assay.

### Example 14 (Comparison)

TPO uptake of a Pure Vision contact lens from Bausch & Lomb. The lenses are taken-off from a commercial package, rinsed with water and treated according to the described TPO assay.

### Example 15 (Comparison)

TPO uptake of an Acuvue Oasis contact lens from Vistakon. The lenses are taken-off from a commercial package, rinsed with water and treated according to the described TPO assay.

TABLE 1

| | Water | | | TPO |
|---|---|---|---|---|
| | Contact Angle (°) | | Sudan Black | Uptake |
| | pH = 7.0 | pH = 2.0 | Staining Grade*) | (nmol) |
| Example 8 | <10 | 36 | 2 | 57 |
| Example 9 | | | | 10 |
| Example 10 | | | | 79 |
| (control) | | | | |
| Example 11 | 47 | 36 | 2 | 1 |
| Example 12 | <10 | 101 | 0 | 89 |
| (control) | | | | |
| Example 13 (Air | | | | 11 |
| Optix Aqua) | | | | |
| Example 14 | | | | 90 |
| (Pure Vision) | | | | |
| Example 15 | | | | 38 |
| (Acuvue Oasis) | | | | |

*)Sudan Black Staining Grade: 0: stained; 1: slightly stained; 2: not or almost not stained

1. A method for producing contact lenses, comprising the steps of:
obtaining a contact lens;
dipping the contact lens in a coating solution comprising an organic solvent and a UV-absorbing polymer for a period of time sufficient to form a coating on the contact lens;
wherein the UV-absorbing polymer comprises
a) UV-absorbing monomeric units,
b) covalently bound radical-initiating moieties,
c) and at least about 50%, preferably at least about 60%, more preferably at least about 70%, even more preferably at least about 80%, most preferably at least about 90%, by mole of carboxyl-containing monomeric units;
and irradiating the contact lens after the dipping step to obtain a photo-induced grafting of the UV-absorbing polymer to the contact lens, in the presence of a hydrophilic vinylic monomer or crosslinker and an in the presence of amino-C2-4-alkyl (meth)acrylamide or an C1-4 alkyl-amino-C2-4-alkyl (meth)acrylamide to form a graft polymer on a contact lens which has a reduction of uptake of cationic compound as comparing to the contact lens prior to the coating treatment.

2. The method of claim 1 comprising a rinsing step between the dipping step and the irradiation step.

3. The method of claim 1 wherein the rinsing is conducted with water.

4. The method of claim 1 comprising, between the dipping step and the irradiation step, a rinsing step, an exposure to an amino-C2-4-alkyl (meth)acrylamide or an C1-4 alkyl-amino-C2-4-alkyl (meth)acrylamide in aqueous solution, and an additional rinsing step.

5. The method of claim 4 wherein the rinsing is conducted with water.

6. The method of claim 1, wherein the irradiation is conducted in the presence of an amino-C2-4-alkyl acrylamide or an amino-C2-4-alkyl (meth)acrylamide.

7. The method of claim 6 wherein the irradiation step is conducted in the presence of aminopropyl methacrylamide, preferably in the presence of N (3-aminopropyl) methacrylamide.

8. The method of claim 1, wherein the covalently bound radical-initiating moieties are derived from a functionalized radical-initiating compound which comprises a group which is co-reactive to carboxy, such as amino or hydroxy, preferably amino.

9. The method of claim 1, wherein the radical-initiating part belongs to the thioxanthone type or to the benzoin type.

10. The method of claim 1, wherein the covalently bound radical-initiating moieties are derived from an Irgacure type photoinitiator.

11. The method of claim 1, wherein each UV-absorbing monomeric unit comprises a benzotriazole or benzophenone moiety or combination thereof.

12. The method of claim 1, wherein the UV-absorbing polymer is obtained from an intermediary UV-absorbing polymer obtained by copolymerizing a polymerizable mixture comprising at least one carboxyl-containing vinylic monomer and at least one UV-absorbing vinylic monomer in the presence or absence of a vinylic monomer, provided that the carboxyl-containing vinylic monomer is present in an amount of at least about 50%, preferably at least about 60%, more preferably at least about 70%, even more preferably at least about 80%, most preferably at least about 90% by mole in the polymerizable composition.

13. The method of claim 1, wherein the UV-absorbing vinylic monomer is selected from the group consisting of 2-(2-hydroxy-5-vinylphenyl)-2H-benzotriazole, 2-(2-hydroxy-5-acrylyloxyphenyl)-2H-benzotriazole, 2-(2-hydroxy-3-methacrylamido methyl-5-tert octylphenyl) benzotriazole, 2-(2′-hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxypropyl-3′-t-butyl-phenyl)-5-chlorobenzotriazole, 2-(2′-hydroxy-5′-methacryloxyethylphenyl) benzotriazole, 2-(2′-hydroxy-5′-methacryloxypropylphenyl) benzotriazole, 2-hydroxy-4-acryloxy alkoxy benzophenone, 2-hydroxy-4-methacryloxy alkoxy benzophenone, allyl-2-hydroxybenzophenone, and 2-hydroxy-4-methacryloxy benzophenone, and combinations thereof; wherein the carboxyl-containing vinylic monomer is selected from the group consisting of acrylic acid, C₁-C₁₂ alkylacrylic acid, N,N-2-acrylamidoglycolic acid, beta-methyl-acrylic acid (crotonic acid), alpha-phenyl acrylic acid, beta-acryloxy propionic acid, sorbic acid, angelic acid, cinnamic acid, 1-carobxy-4-phenyl butadiene-1,3, itaconic acid, citraconic acid, mesaconic acid, glutaconic acid, aconitic acid, maleic acid, fumaric acid, tricarboxy ethylene, and combinations thereof, preferably from the group consisting of acrylic acid, C₁-C₆ alkylacrylic acid, and combinations thereof.

14. The method of claim 1, wherein the UV-absorbing polymer is obtained by: reacting a precursor polymer having at least about 50% (preferably at least about 60%, more preferably at least about 70%, even more preferably at least about 80%, most preferably at least about 90%) by mole of carboxyl-containing monomeric units, in a coupling reaction, simultaneously or sequentially with a UV-absorbing compound and a radical-initiating compound,
wherein the UV-absorbing compound is represented by formula I, II, III, or IV 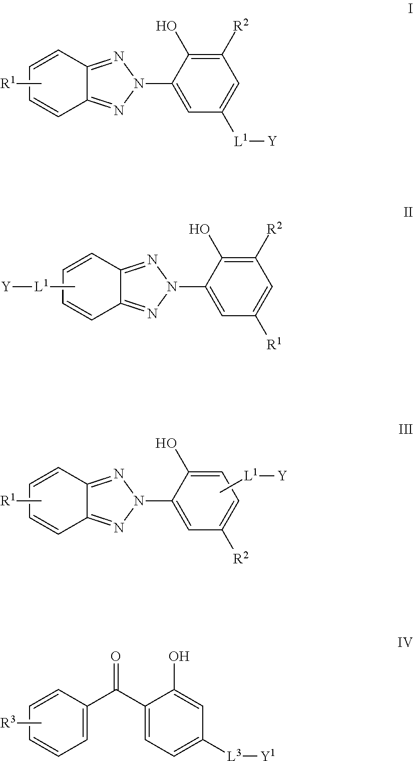
in which
R¹, R² and R³ independently of one other are hydrogen, a C₁-C₁₂ linear or branched alkyl group, a halogen (Cl or Br), a C₆ to C₂₄ aryl group, a C₇ to C₂₄ alkylaryl group, a C₇ to C₂₄ arylalkyl, or a C₁-C₁₂ linear or branched alkoxy group;
L¹ and L³ independent of each other are a covalent bond or a divalent radical of —Xₐ-E₁-X_{b}-E₂-X_{c}— in which Xₐ is a covalent bond, —O—, carbonyl 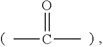
a divalent radical of —(R^{a}O)ₙ— in which R^{a} is a linear or branched C₁-C₁₂-alkylene and n is from 1 to 10, 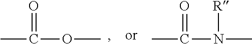
in which R″ is H or C₁-C₈ alkyl, E₁ and E₂ independently of each other are a covalent bond, a divalent radical of —(R^{a}O)ₙ— in which R^{a} and n are defined above, 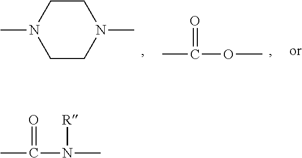
in which R″ is H or C₁-C₈ alkyl, a C₁ to C₁₂ linear or branched alkylene divalent radical, a cycloalkyl divalent radical with up to 40 carbon atoms, an alkylcycloalkyl divalent radical with up to 40 carbon atoms, an alkylaryl divalent radical with up to 40 carbon atoms, an arylalkylene divalent radical with up to 40 carbon atoms, or a dicarbonyl group having the formula —C(O)L²C(O)— in which L² is a C₁ to C₁₂ linear or branched alkylene divalent radical or —(R^{e1}—O)_{w1}—(R^{e2}—O)_{w2}—(R^{e3}—O)_{w3}—, wherein R^{e1}, R^{e2}, and R^{e3} independently of one another are a linear or branched C₁-C₄-alkylene and w1, w2 and w3 independently of one another are a number from 0 to 20 provided that the sum of (n+m+p) is 1 to 60, and X_{b} and X_{c} independently of each other are a covalent bond, carbonyl, 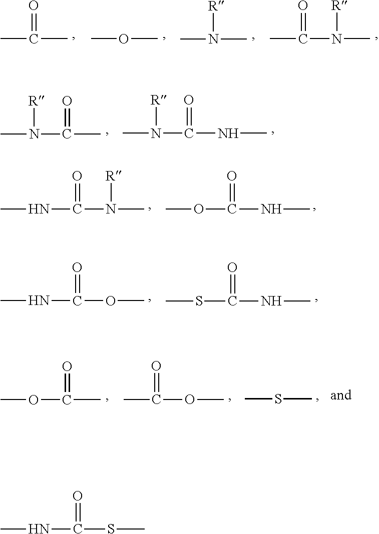
in which R″ is defined above; and
Y and Y¹ independent of each other are an azlactone group, an epoxy group, an isocyanate group, an aziridine group, or an amino group of —NHR in which R is hydrogen or a C₁-C₂₀ unsubstituted or substituted, linear or branched alkyl group,
wherein the radical-initiating compound has a functional group reactive with a carboxy group.

15. The method of claim 1, wherein the ophthalmic lens is a silicone hydrogel contact lens which has a surface wettability characterized by having an averaged water contact angle of about 90 degrees or less, preferably about 80 degrees or less, more preferably about 70 degrees or less, even more preferably about 60 degrees or less, most preferably about 50 degrees or less.

16. The method of claim 1, wherein the silicone hydrogel contact lens is a daily wear contact lens.

17. An ophthalmic lens obtained according to the method of claim 1.
